(19) United States
(12) Patent Application Publication
(10) Pub. No.: US 2012/0162027 A1
(43) Pub. Date: Jun. 28, 2012

(54) Antenna Arrangement For A Portable Radio Communication Device

(76) Inventors: Marek Chacinski, Farsta (SE); Andrei Kaikkonen, Jarfalla (SE); Johan Backman, Taby (SE); Lukasz Grynczel, Sollentuna (SE)

(21) Appl. No.: 13/333,092

(22) Filed: Dec. 21, 2011

(30) Foreign Application Priority Data
Dec. 22, 2010 (EP) 10196418.7

(51) Int. Cl. H01Q 1/24

(52) U.S. Cl. 343/702

(57) ABSTRACT

Exemplary embodiments are disclosed of antenna arrangements for portable radio communication devices. In an exemplary embodiment, there is an antenna arrangement for a portable communication device having a metal casing. A front side part forms a ground plane means for the portable radio communication device. A first back side part is connected to the front side part through a top side part. A second back side part is connected to the front side part through a bottom side part. The top and bottom side parts are positioned at opposite ends of the front side part. The first and second back side parts are positioned and distanced from each other by a gap. A magnetic type antenna element is positioned partly in the gap and positioned partly over or along the first back side part, the top side part, or the front side part.

### CROSS REFERENCE TO RELATED APPLICATION

This application claims priority to European application No. EP 10196418.7 filed Dec. 22, 2010. The entire disclosure of the above application is incorporated herein by reference.

### FIELD

The present disclosure relates generally to antennas for radio communication devices, and particularly to antenna arrangements for portable radio communication devices.

### BACKGROUND

This section provides background information related to the present disclosure which is not necessarily prior art.

A current trend for portable radio communication devices, such as mobile phones, PDA, portable computers, and similar devices, is to provide the device with a metal casing. A metal casing for a portable radio communication device makes it difficult to provide the device with a non-protruding antenna, as the metal casing shields the interior of the device for radio frequencies. It is heretofore possible to only partly provide the casing as a metal casing to allow the use of a built in antenna. But the inventors hereof have recognized that it would be desirable to provide the casing as a full metal casing.

Another trend for portable radio communication devices, such as mobile phones and similar devices, is to provide the device with a wide coverage of frequency band covering, for example, GSM850, GSM900, GSM1800, GSM1900, UMTS 2100 MHz, GPS, BT (Bluetooth), WLAN 2.4 GHz, and NFC (Near Field Communication), etc. This puts further restrictions on the design of an antenna for a portable radio communication device.

### SUMMARY

This section provides a general summary of the disclosure, and is not a comprehensive disclosure of its full scope or all of its features.

Exemplary embodiments are disclosed of antenna arrangements for portable radio communication devices. In an exemplary embodiment, there is an antenna arrangement for a portable communication device having a metal casing. A front side part forms a ground plane means for the portable radio communication device. A first back side part is connected to the front side part through a top side part. A second back side part is connected to the front side part through a bottom side part. The top and bottom side parts are positioned at opposite ends of the front side part. The first and second back side parts are positioned and distanced from each other by a gap. A magnetic type antenna element is positioned partly in the gap and positioned partly over or along the first back side part, the top side part, or the front side part.

Another exemplary embodiment provides a portable radio communication device that includes a magnetic type antenna element and a metal casing. The metal casing includes a front side part forming a ground plane means for the portable radio communication device. The metal casing also includes a first back side part connected to the front side part through a top side part, and a second back side part connected to the front side part through a bottom side part. The top and bottom side parts are positioned at opposite ends of the front side part. The first and second back side parts are positioned and distanced from each other by a gap. The magnetic type antenna element is positioned partly in the gap and positioned partly over or along at least one of the first back side part, the top side part, or the front side part.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 schematically shows a first embodiment of an antenna arrangement for a portable radio communication device.

FIG. 2 schematically shows a side view of the antenna arrangement shown in FIG. 1.

FIG. 3 schematically shows a side view of a variant of the antenna arrangement shown in FIG. 2.

FIG. 4 schematically shows a second embodiment of an antenna arrangement for a portable radio communication device.

FIG. 5 schematically shows a top view of an antenna arrangement for a portable radio communication device according to a third embodiment.

Corresponding reference numerals indicate corresponding parts throughout the several views of the drawings.

### DETAILED DESCRIPTION

Example embodiments will now be described more fully with reference to the accompanying drawings.

Exemplary embodiments are disclosed that provide an antenna arrangement for a portable radio communication device having a metal casing, while still allowing or accommodating for a magnetic type antenna to be provided in the portable radio communication device. In an exemplary embodiment, there is provided an antenna arrangement for a portable radio communication device having a metal casing. The metal casing includes a front side part that forms a ground plane means for the portable radio communication device. A first back side part is connected to the front side part through a top side part. A second back side part is connected to the front side part through a bottom side part. The top and bottom side parts are positioned at opposite ends of the front side part. The first and second back side parts are positioned and distanced from each other by a gap. The front side part and back side part form a back piece of the metal casing for the portable radio communication device. A magnetic type antenna element is positioned partly in the gap and positioned partly over or along the first back side part, the top side part, and/or the front side part.

In exemplary embodiments, the first back side part preferably comprises a feed point and a ground point positioned at the gap, which thereby can be utilized for communication, such as cellular communication. This positioning of the feeding and grounding at the gap facilitates the provision of a broad high-frequency band.

Also in exemplary embodiments, the second back side part preferably comprises a feed point positioned at the gap, which thereby can be utilized for communication, such as cellular communication. The feed point for the second back side part is preferably positioned at a corner at the gap to facilitate the provision of a broad low-frequency band.

The magnetic type antenna element is preferably a Near Field Communication (NFC) antenna element, to provide the portable radio communication device with NFC capability in exemplary embodiments. By way of example, the NFC antenna element preferably comprises a multiple-turn loop.

The antenna arrangement preferably comprises a ferrite positioned at least partly between the magnetic type antenna element and the first back side part, the top side part or the front side part over or along which the magnetic type antenna element is positioned. This positions helps improve NFC performance in such exemplary embodiments.

To help improve antenna performance for the first back side part in exemplary embodiments, the antenna arrangement preferably comprises bridges partly over the magnetic type antenna element positioned in the gap, distanced by a dielectric material. In exemplary embodiments, the antenna arrangement preferably comprises two bridges, positioned near each end of the gap. The purpose of the bridges over the magnetic type antenna element is to electrically shorten it for high frequencies of about 1 Gigahertz (GHz) to about 2 GHz.

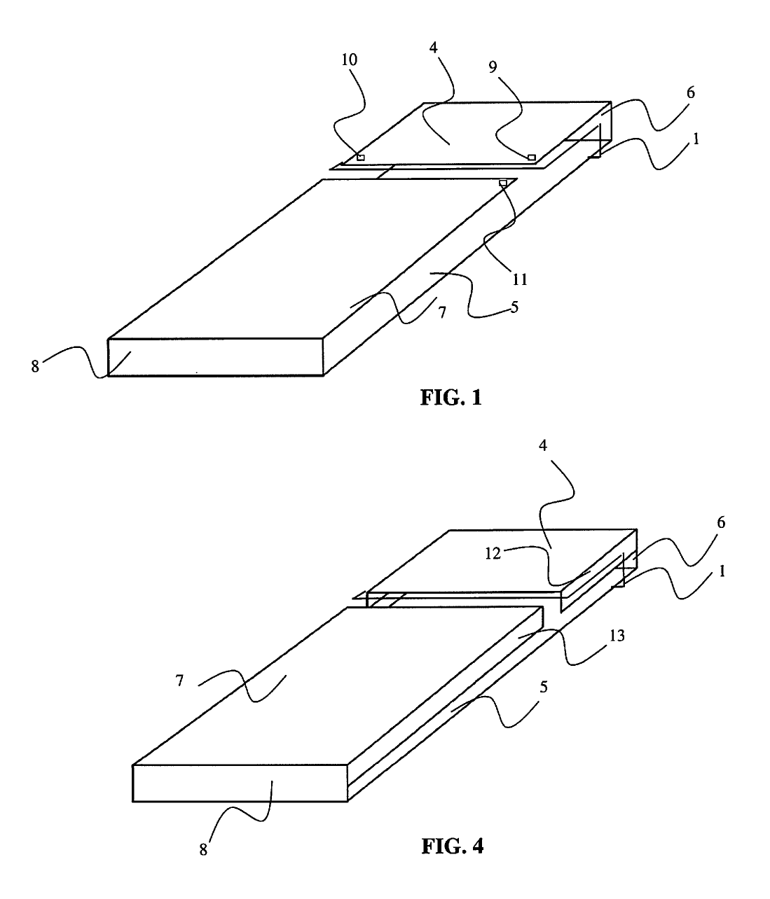

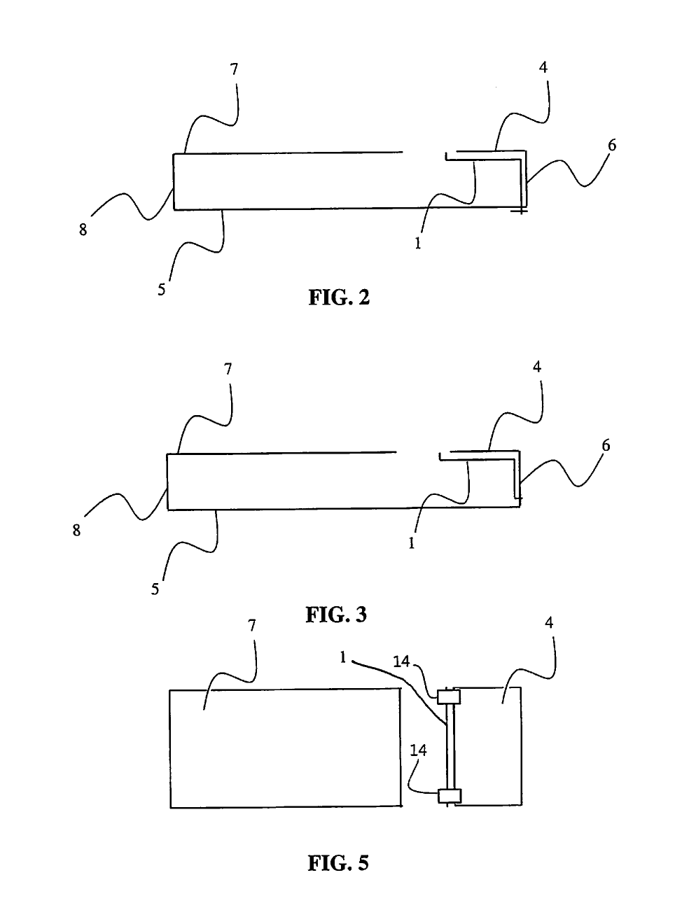

With reference now to the figures, FIGS. 1 and 2 illustrate a first exemplary embodiment of an antenna arrangement for a portable radio communication device having a metal casing. The portable radio communication device, such as a mobile phone, has a sheet metal casing and a display mounted in or above a front side part of the sheet metal casing. Components for operation of the portable radio communication device are as usually provided within its housing, which in this embodiment would be within the sheet metal casing. The display is preferably a touch-screen display occupying a major part of the front side of the sheet metal casing, but the portable radio communication device may alternatively, for example, comprise a display and separate key pad.

The back piece of the metal casing is divided into two parts. A first back side part 4 is connected to the front side part 5 of the metal casing through a top side part 6. A second back side part 7 is connected to the front side part 5 of the metal casing through a bottom side part 8. The first back side part 4 and the second back side part 7 are positioned and distanced from each other by a gap of about 5 millimeters (mm) to about 10 mm.

In this exemplary embodiment of the antenna arrangement, the front side part 5 of the metal casing forms a ground plane means for the portable radio communication device. The first back side part 4 is connected to the front side part 5 through the top side part 6. The second back side part 7 is connected to the front side part 5 through the bottom side part 8.

A magnetic type antenna element 1 is positioned partly in the gap and positioned partly over the front side part 5. The magnetic type antenna element 1 is preferably a multiple-turn loop element, configured for NFC communication. The turns are arranged along the gap, along the open sides of the metal casing and over the front side part 5. In this exemplary configuration, an NFC communication direction of about 45 degrees from the top of the portable radio communication device is achievable. For improved functionality of the NFC antenna, a ferrite is preferably at least partly arranged between the front side part 5 and the parts of the turns positioned over the front side part 5. Feeding of the NFC antenna may be arranged anywhere of the magnetic type antenna element 1 in view of NFC functionality.

The first back side part 4 is preferably driven as a multi-band high-frequency antenna element by being fed at a feed point 9 at a corner near the gap against the second back side part 7, by being grounded at a ground point 10 at an opposite corner near the gap against the second back side part 7, and by being grounded along the top side part 6. For a mobile phone, and thus its metal casing, having a length of about 110 mm, a width of about 50 mm, and a thickness of about 9 mm, a frequency band coverage of about 1550-2500 MHz is achievable. In this example, the first back side part 4 has a generally rectangular shape having a length of about 30 mm and a width of about 50 mm.

The second back side part 7 is preferably driven as a multi-band low-frequency antenna element by being fed at a feed point 11 at a corner near the gap against the first back side part 4, and by being grounded along the bottom side part 8. For a mobile phone, and thus its metal casing, having a length of about 110 mm, a width of about 50 mm, and a thickness of about 9 mm, a frequency band coverage of about 750-1050 MHz is achievable. In this example, the second back side part 7 has a generally rectangular shape having a length of about 72 mm and a width of about 50 mm.

The first back side part 4 and second back side part 7 are operable for functioning as radiating elements over a ground plane (over the front side part 5). In this way, a robust antenna is achieved by the first and second back side parts 4 and 7, respectively, being connected to the front side part 5 through a large grounding means, which in this example are the top and bottom side parts 6, 8, respectively. A display device and/or a key pad are typically provided with grounded shielding means between the inner of the portable radio communication device and the display device and/or the key pad. The grounded shielding means then form part of the front side part 5. Further, in a mobile phone e.g. having a touch-screen display occupying essentially the whole front thereof, the front side part 5 of the metal casing will then be made up by the shielding means of the touch screen.

The first and second back side parts 4 and 7 have been described as having feed points 9 and 11. Feeding of the feed points 9 and 11 is advantageously provided as two separate feedings to radio frequency (RF) circuitry, to help improve isolation therebetween. But the feeding of the feed points 9 and 11 could alternatively be provided as a common feeding having filtering means to separate signaling to and from RF circuitry.

The second back side part 7 preferably covers the whole battery of a mobile phone. The second back side part 7 is preferably pivotable around and/or detachably attached to the bottom side part 8 to facilitate access into the mobile phone, e.g., for changing battery or for changing a subscriber identity module (SIM) of the mobile phone.

The top and bottom side parts 6, 8 have been illustrated as parts covering the top and bottom side respectively, of the portable radio communication device. But the top and bottom side parts 6, 8 can alternatively comprise a plurality of grounding portions together not completely covering the top or bottom side, respectively.

For improved antenna function, the metal casing is preferably made up by, or metalized by, a good electrically conductive material.

Although the first back side part 4 has been described as generating the high frequency band and the second back side part 7 has been described as generating the low frequency band, the opposite is also possible. Also, either the first or the second back side part could generate both low and high frequency bands.

FIG. 3 illustrates a variant of the magnetic type antenna element 1. In this example, the magnetic type antenna element 1 is positioned partly over or along the top side part 6 instead of partly over or along the front side part 5. In yet another variant (not shown), the magnetic type antenna element is positioned partly over or along the top side part instead of over the front side part.

FIG. 4 illustrates a second exemplary embodiment of an antenna arrangement for a portable radio communication device. This second embodiment is similar to the first embodiment described above apart from that the first and second back side parts 4 and 7 comprise folded side edge portions 12 and 13, respectively, that extend towards the front side part 5. In this example, the folded side edge portions 12 and 13 extend about 6 mm and thus leaving a gap of about 3 mm to the front side part 5. Although the folded side edge portions 12, 13 have been illustrated as covering the whole or extending along the entirety of the first and second back side parts 4 and 7, it is also possible to only have portions of the first and second back side parts 4 and 7 folded towards the front side part 5. Alternatively, the edges of the front side part 5 may instead, or additionally, be folded to extend towards the first and second back side parts 4 and 7 in other embodiments.

In this illustrated embodiment, FIG. 4 shows the magnetic type antenna element 1 positioned also partly over the folded side edge portions 12 of the first back side part 4. Advantageously, parts of the magnetic type antenna element 1 over the folded side edges are at least partly distanced by a ferrite.

FIG. 5 is a top view of a third exemplary embodiment of an antenna arrangement for a portable radio communication device. This third embodiment is similar to the first embodiment described above apart from that the antenna arrangement comprises two bridges 14 from the first back side part 4 that extend partly across the gap between the first and second back side parts 4 and 7. The bridges 14 partly extend over the magnetic type antenna element 1, preferably distanced by a dielectric layer. By positioning one or more bridges 14 over the magnetic type antenna element 1, the cellular type antenna element does not couple to the magnetic type antenna element 1, and performance, particularly high-frequency bands, does not couple to the magnetic type antenna element 1. The bridges 14 are electrically connected to the first back side part 4 and extend over the magnetic type antenna element 1. The bridges 14 may, for example, be integral parts of the first back side part 4. Alternatively, the bridges 14 may be separate electrically conductive parts electrically connected to the first back side part 4.

In another exemplary embodiment, the second and third embodiments may also be combined. In such exemplary embodiment, the antenna arrangement includes bridges 14 (FIG. 5) and folded side edge portions 12 and 13 (FIG. 4).

The dimensions provided herein are for purposes of illustration only as the particular dimensions may vary depending on the particular application. The particular dimensions and values provided are not intended to limit the scope of the present disclosure.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter. The disclosure of a first value and a second value for a given parameter can be interpreted as disclosing that any value between the first and second values could also be employed for the given parameter. Similarly, it is envisioned that disclosure of two or more ranges of values for a parameter (whether such ranges are nested, overlapping or distinct) subsume all possible combination of ranges for the value that might be claimed using endpoints of the disclosed ranges.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. An antenna arrangement for a portable radio communication device having a metal casing, the antenna arrangement comprising:
a front side part forming a ground plane means for the portable radio communication device;
a first back side part connected to the front side part through a top side part;
a second back side part connected to the front side part through a bottom side part;
a magnetic type antenna element;
wherein the top and bottom side parts are positioned at opposite ends of the front side part;
wherein the first and second back side parts are positioned and distanced from each other by a gap;
wherein the front side part and the back side part form a back piece of the metal casing for the portable radio communication device; and
wherein the magnetic type antenna element is positioned partly in the gap and positioned partly over or along at least one of the first back side part, the top side part, or the front side part.

2. The antenna arrangement according to claim 1, wherein the first back side part comprises a feed point and a ground point positioned at the gap.

3. The antenna arrangement according to claim 2, wherein:
the feed point is positioned at a corner at the gap; and
the ground point is positioned at a corner at the gap, opposite the corner at which the feed point is positioned.

4. The antenna arrangement according to claim 1, wherein the second back side part comprises a feed point positioned at the gap.

5. The antenna arrangement according to claim 4, wherein the feed point is positioned at a corner at the gap.

6. The antenna arrangement according to claim 1, wherein the second back side part comprises a ground point.

7. The antenna arrangement according to claim 1, wherein:
the first back side part comprises a feed point positioned at the gap; and
the second back side part comprises a feed point positioned at the gap adjacent the feed point of the first back side part.

8. The antenna arrangement according to claim 1, wherein the magnetic type antenna element is a NFC antenna element.

9. The antenna arrangement according to claim 8, wherein the NFC antenna element comprises a multiple-turn loop element.

10. The antenna arrangement according to claim 1, further comprising a ferrite positioned at least partly between the magnetic type antenna element and the at least one of the first back side part, the top side part, or the front side part over or along which the magnetic type antenna element is positioned.

11. The antenna arrangement according to 1, further comprising at least one bridge from the first back side part extending over the magnetic type antenna element positioned in the gap and distanced by a dielectric material.

12. The antenna arrangement according to claim 11, wherein the at least one bridge comprises two grounding bridges positioned near each end of the gap.

13. The antenna arrangement of claim 1, wherein the magnetic type antenna element is positioned partly over or along the first back side part and the top side part.

14. The antenna arrangement of claim 1, wherein at least one of the first and second back side parts include folded side edge portions extending toward the front side part with a gap therebetween.

15. A portable radio communication device comprising a metal casing and the antenna arrangement according to claim 1, wherein the metal casing includes the front side part, the first and second back side parts, and the top and bottom side parts.

16. An antenna arrangement for a portable radio communication device, the antenna arrangement comprising:
a front side part;
a first back side part connected to the front side part through a top side part;
a second back side part connected to the front side part through a bottom side part;
a magnetic type antenna element having a multiple-turn loop element positioned partly over or along at least one of the top side part or the front side part;
wherein the bottom side part and the top side part are positioned at opposite ends of the front side part; and
wherein the first and second back side parts form a back piece for the portable radio communication device.

17. The antenna arrangement of claim 16, wherein:
the magnetic type antenna element is positioned partly over and along the top side part and the first back side part; and/or
the magnetic type antenna element is positioned partly in a gap between the first back side part and the second back side part; and/or
the magnetic type antenna element is a NFC antenna element.

18. The antenna arrangement of claim 16, wherein the antenna arrangement further comprises:
a ferrite positioned at least partly between the magnetic type antenna element and the at least one of the top side part or the front side part over or along which the magnetic type antenna element is positioned; and/or
at least one bridge from the first back side part extending over a portion of the magnetic type antenna element; and/or
one or more folded side edge portions of at least one of the first and second back side parts, that extend toward the front side part with a gap therebetween.

19. A portable radio communication device having a metal casing and the antenna arrangement of claim 16, wherein the metal casing includes the front side part, the first and second back side parts, and the top and bottom side parts.

20. A portable radio communication device comprising a magnetic type antenna element and a metal casing, the metal casing including:
a front side part forming a ground plane means for the portable radio communication device;
a first back side part connected to the front side part through a top side part;
a second back side part connected to the front side part through a bottom side part;
wherein the top and bottom side parts are positioned at opposite ends of the front side part;
wherein the first and second back side parts are positioned and distanced from each other by a gap;
wherein the magnetic type antenna element is positioned partly in the gap and positioned partly over or along at least one of the first back side part, the top side part, or the front side part.
